(19) United States
(12) Patent Application Publication
(10) Pub. No.: US 2012/0240715 A1
(43) Pub. Date: Sep. 27, 2012

(54) BRAKING DEVICE WITH HIDDEN HYDRAULIC CYLINDER

(75) Inventor: SZU-FANG TSAI, CHANGHUA (TW)

(73) Assignee: TEKTRO TECHNOLOGY CORPORATION, CHANGHUA (TW)

(21) Appl. No.: 13/070,493

(22) Filed: Mar. 24, 2011

(51) Int. Cl. B62L 3/02; G05G 1/04

(52) U.S. Cl. 74/504

(57) ABSTRACT

A braking device with a hidden hydraulic cylinder has a hydraulic cylinder hidden inside a body of the braking device and further protected by a casing made of plastics, rubber or light alloy. Thereby, the space can be saved and any leakage due to unexpected collision. A tube is mounted to the hydraulic cylinder at any angle, preventing any wear or breaks due to frequent use. Therefore, the braking device of this invention is particularly suitable to the road bicycle.

### BACKGROUND OF THE INVENTION

1. Field of the Invention

The present invention relates to a braking device, particularly to a braking device with a hidden hydraulic cylinder for a road bicycle.

2. Description of Related Art

A conventional braking device for a bicycle is a brake hinged on a bicycle frame and reaches braking effect by clipping two brake pads on wheel rim.

In order to meet the requirements for innovation and special purpose such as bicycle race, a conventional braking device has not satisfied for the user's demand of pursuing high-quality product. A disc break type brake has come to replace the conventional one.

In order to control the disc brakes, a hydraulic cylinder is connected to a braking handlebar and a tube. Since the hydraulic cylinder must be mounted on an external surface of the bicycle, there causes inconvenience for the user in use and it is easy to cause leakage if any unexpected collision occurs. The tube is fixedly mounted in manner of being bent, which intends to cause wear or breaks and thus leakage. Therefore, the brake cannot fit to different types of bicycles, limiting its application.

Therefore, there is a need of a novel braking device with a hidden hydraulic cylinder which overcomes the above disadvantages.

### SUMMARY OF THE INVENTION

The object of the present invention is to provide a braking device with a hidden hydraulic cylinder, in which the hydraulic cylinder is hidden inside the body and protected by a casing made of plastics, rubber or light alloy in order to save space and prevent leakage due to unexpected collision.

Furthermore, the tube can be mounted to the hydraulic cylinder at any angle so that the braking device can be applied to different types of bicycles, with any wear or break due to being bent frequently.

In order to achieve the above and other objectives, a braking device with a hidden hydraulic cylinder includes a body having an accommodating section, a pivoting terminal and an open terminal; a hydraulic unit hidden inside the accommodating section; and a handlebar pivotally connected to the pivoting terminal.

The hydraulic unit has a hydraulic cylinder, a pushing rod, a piston, an elastic element and a tube. The hydraulic cylinder is embedded inside the accommodating section. One end of the pushing rod is connected handlebar close to pivoting terminal so that the handlebar drives the pushing rod to act. The piston and the elastic element can be movably mounted in one space of the hydraulic cylinder. The other end of the pushing rod opposite to the handlebar urges against one side of the piston. The other side of the piston opposite to the pushing rod urges against one end of the elastic element; the other end of the elastic element opposite to the piston urges against one inner side of the hydraulic cylinder. One end of the tube connects to the hydraulic cylinder near the elastic element, urging against one side of the hydraulic cylinder and extending from the open terminal.

The tube is adjustable to any angle for connecting the hydraulic cylinder, and mounted to the open terminal at any angle.

The braking device further has a casing made of rubber, plastics or light alloy at each side of the body.

In order to further the understanding regarding the present invention, the following embodiments are provided along with illustrations to facilitate the disclosure of the present invention.

### BRIEF DESCRIPTION OF THE DRAWINGS

FIG. 1 is a perspective view of a braking device according to the invention.

FIG. 2 is an exploded view of a braking device according to the invention.

FIG. 3 is a perspective view of a braking device according to the invention.

FIG. 4 is a schematic view of a part of a braking device applied onto a racing bicycle according to the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

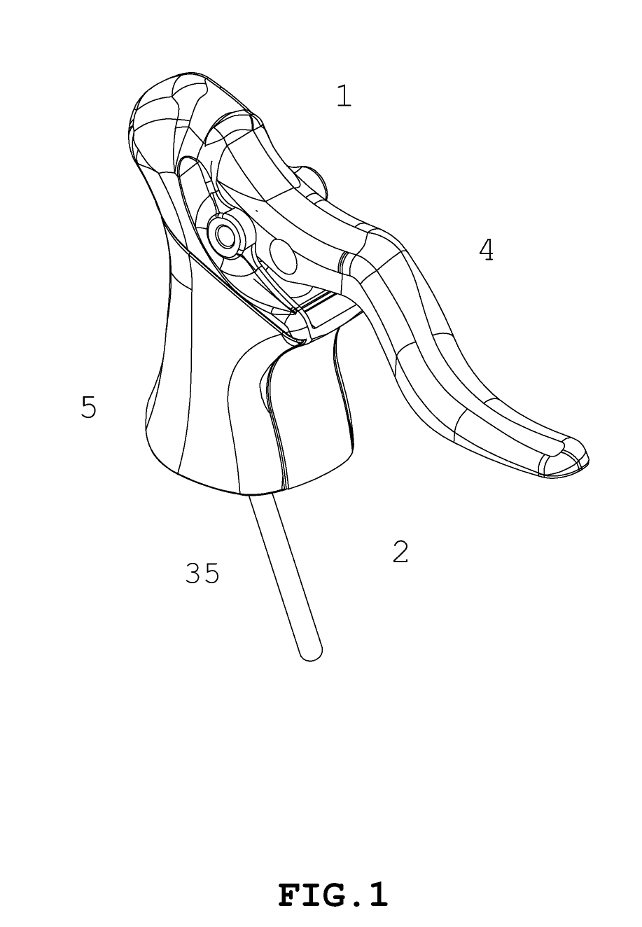

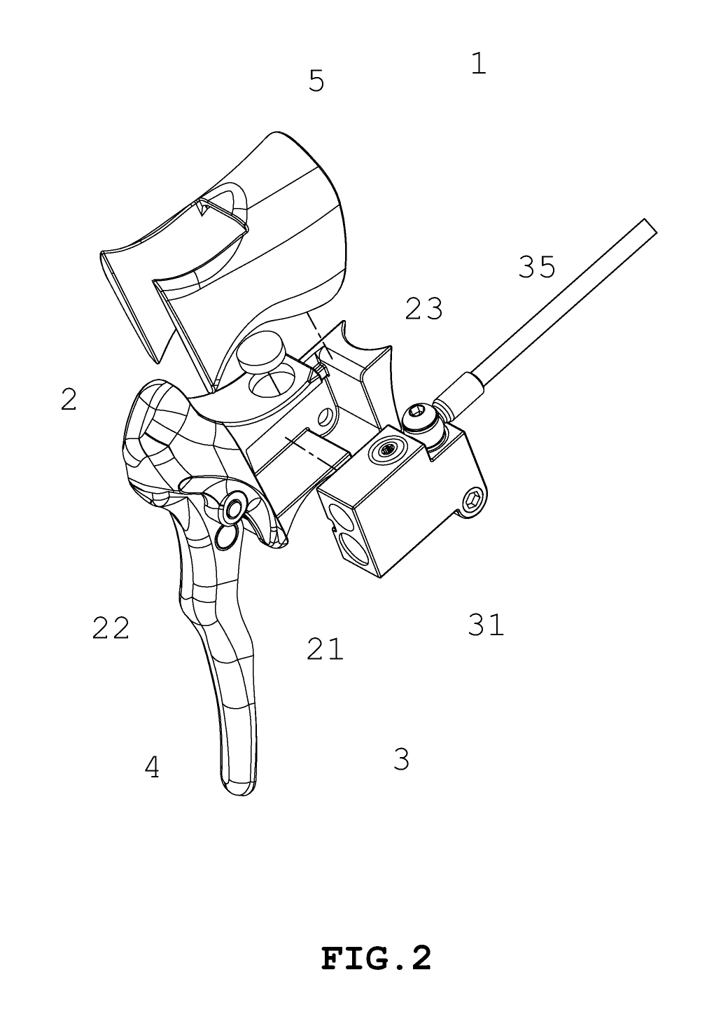

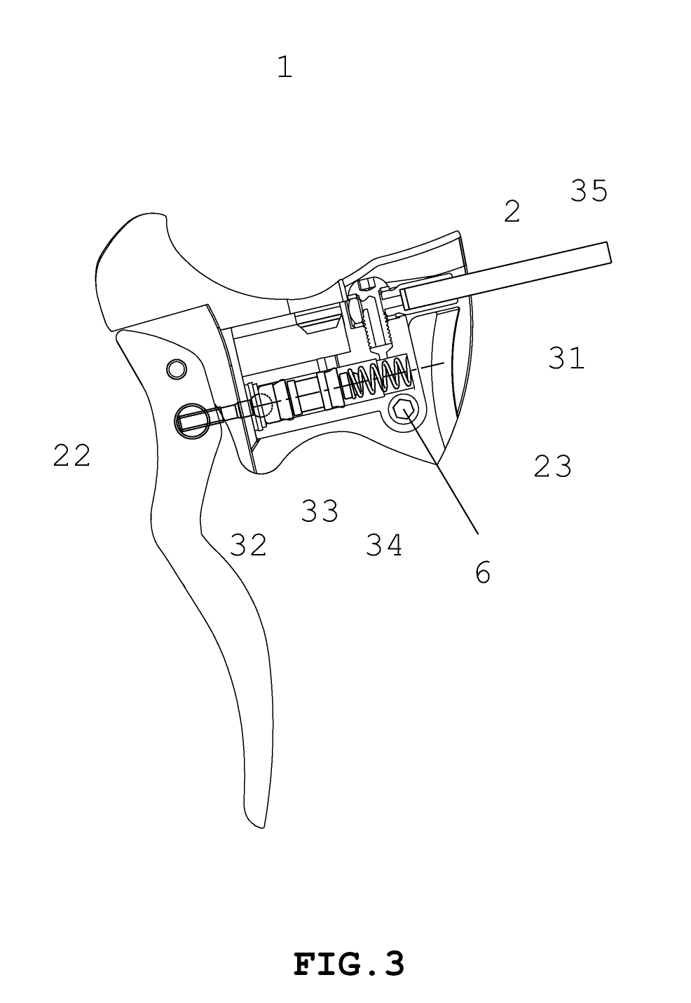

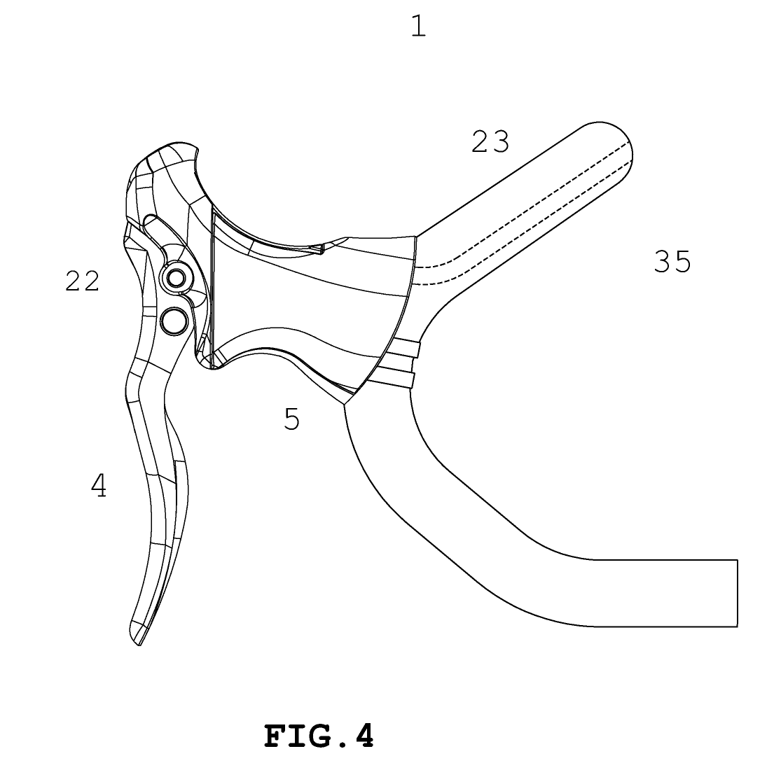

FIG. 1 is a perspective view of a braking device according to the invention. FIG. 2 is an exploded view of a braking device according to the invention. FIG. 3 is a perspective view of a braking device according to the invention. FIG. 4 is a schematic view of a part of a braking device applied onto a racing bicycle according to the invention.

The braking device 1 of the invention includes a body 2, a hydraulic unit 3 and a handlebar 4.

The body 2 has an accommodating section 21, a pivoting terminal 22 and an open terminal 23. The handlebar 4 can be pivotally connected to the pivoting terminal 22.

The hydraulic unit 3 is hidden inside the accommodating section 21. The way to hide the hydraulic unit 3 inside the accommodating section 21 can be achieved by forming the hydraulic unit 3 and the accommodating section 21 integrally. More specifically, the hydraulic unit 3 has a hydraulic cylinder 31, a pushing rod 32, a piston 33, an elastic element 34 and a tube 35. The hydraulic cylinder 31 is embedded inside the accommodating section 21 and is fixed by means of screws 6 in pair. One end of the pushing rod 32 is connected handlebar 4 close to pivoting terminal 22 so that the handlebar 4 drives the pushing rod 32 to act. The piston 33 and the elastic element 34 can be movably mounted in one space of the hydraulic cylinder 31. The other end of the pushing rod 32 opposite to the handlebar 4 urges against one side of the piston 33. The other side of the piston 33 opposite to the pushing rod 32 urges against one end of the elastic element 34. The other end of the elastic element 34 opposite to the piston 33 urges against one inner side of the hydraulic cylinder 31. One end of the tube 35 connects to the hydraulic cylinder 31 near the elastic element 34, urging against one side of the hydraulic cylinder 31 and extending from the open terminal 23.

The tube 35 is adjustable to any angle for connecting the hydraulic cylinder 31, and mounted to the open terminal 23 at any angle. In applying to different types of bicycles such as road bikes or non-race bikes, the tube will not wear or break due to frequent use.

Furthermore, the braking device 1 of the invention further includes a casing 5 which covers the side of the body 2. The casing 5 can be made of rubber, plastics or light alloy so as to protect the body 2 and the hydraulic unit 3 from being exposed and wore down.

Therefore, by means of hiding the hydraulic unit 3 inside the body 2, the body 2 will not be exposed and thereby the total space can be saved. The casing 5 of rubber, plastics or light alloy covers the body 2 and the hydraulic cylinder 3 so that the body 2 and the hydraulic unit 3 can be protected from leakage due to unexpected collision. Furthermore, the tube 35 can be mounted to the hydraulic cylinder 31 at any angle. The braking device of the invention is particularly suitable for road bikes for the tube will not wear or break due to being long-term bent.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A braking device with a hidden hydraulic cylinder, comprising:
a body, having an accommodating section, a pivoting terminal and an open terminal;
a hydraulic unit, hidden inside the accommodating section; and
a handlebar, pivotally connected to the pivoting terminal.

2. The braking device with a hidden hydraulic cylinder of claim 1, wherein the hydraulic unit has a hydraulic cylinder, a pushing rod, a piston, an elastic element and a tube; the hydraulic cylinder is embedded inside the accommodating section; one end of the pushing rod is connected handlebar close to pivoting terminal so that the handlebar drives the pushing rod to act; the piston and the elastic element can be movably mounted in one space of the hydraulic cylinder; the other end of the pushing rod opposite to the handlebar urges against one side of the piston; the other side of the piston opposite to the pushing rod urges against one end of the elastic element; the other end of the elastic element opposite to the piston urges against one inner side of the hydraulic cylinder; and one end of the tube connects to the hydraulic cylinder near the elastic element, urging against one side of the hydraulic cylinder and extending from the open terminal.

3. The braking device with a hidden hydraulic cylinder of claim 2, wherein the tube is adjustable to any angle for connecting the hydraulic cylinder, and mounted to the open terminal at any angle.

4. The braking device with a hidden hydraulic cylinder of claim 1, further comprising a casing to cover the side the body.

5. The braking device with a hidden hydraulic cylinder of claim 4, wherein the casing is made of rubber, plastics or light alloy.

6. The braking device with a hidden hydraulic cylinder of claim 1, wherein the hydraulic unit is formed integrally with the body to be inside the accommodating section.
